(19) United States
(12) Patent Application Publication
(10) Pub. No.: US 2013/0078154 A1
(43) Pub. Date: Mar. 28, 2013

(54) SYSTEM FOR REFRACTORY LAYER MEASUREMENT

(71) Applicants: Kevin Michael Sullivan, Jersey Village, TX (US); Shobhana Mani, Houston, TX (US); Aaron Avagliano, Houston, TX (US)

(72) Inventors: Kevin Michael Sullivan, Jersey Village, TX (US); Shobhana Mani, Houston, TX (US); Aaron Avagliano, Houston, TX (US)

(73) Assignee: General Electric Company, Schenectady, NY (US)

(21) Appl. No.: 13/242,410

(22) Filed: Sep. 23, 2011

(51) Int. Cl. B01J 7/00

(52) U.S. Cl. 422/119

(57) ABSTRACT

The present embodiments are directed toward a system for measuring a refractory layer of a gasifier. In one embodiment, the gasifier includes a first refractory layer disposed about a gasification chamber, a second refractory layer disposed about the first refractory layer, and a temperature sensor disposed between the first refractory layer and the second refractory layer. The temperature sensor may collect temperature data for use in determining a thickness of the first refractory layer.

### BACKGROUND OF THE INVENTION

The subject matter disclosed herein relates to refractory layers, and, more particularly, to systems for refracting layer measurements.

A refractory liner, including one or more refractory layers, may be used to protect a variety of reactors, such as gasifiers. A gasifier is designed to generate a synthesis gas, or syngas, by reacting a carbonaceous feedstock with oxygen and/or steam. The refractory liner insulates the gasifier to contain the harsh, high-temperature environment associated with gasification. Unfortunately, this environment gradually wears the refractory liner, causing periodic downtime for inspection and replacement. For example, the gasifier may be taken offline for several days to measure the refractory liner thickness, which may be used to determine an amount of wear and the possible need for a replacement refractory liner. Each time the gasifier is taken offline, the refractory liner is subjected to thermal stress due to the cooling between operating temperatures and ambient temperatures. Therefore, a need exists to reduce thermal stress and downtime associated with refractory liner measurements.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gasifier having a first refractory layer disposed about a gasification chamber and a second refractory layer disposed about the first refractory layer. The gasifier further includes an enclosure disposed about the first refractory layer and a first temperature sensor disposed between the first and second refractory layers.

In a second embodiment, a system includes a gasifier having a first refractory layer comprising a plurality of first refractory bricks disposed about a gasification chamber and a second refractory layer comprising a plurality of second refractory bricks disposed about the first refractory layer.

In a third embodiment, a system includes a first gasifier brick having a gasification hot face configured to face a gasification chamber inside a gasifier, a protected face opposite from the gasification hot face and a sensor mount disposed along the protected face.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a gasifier system including a gasifier having sensors disposed between two or more refractory layers in accordance with an embodiment of the present invention;

FIG. 2 is a cross-sectional top view of an embodiment of the gasifier of FIG. 1, taken along line 2-2, having sensors disposed between two refractory layers that are formed by refractory bricks;

FIG. 3 is a cross-sectional top view of an embodiment of the gasifier of FIG. 1, taken along line 2-2, having sensors disposed between three refractory layers that are formed by refractory bricks;

FIG. 4 is a partial cross-sectional side view of an embodiment of a gasifier refractory lining with a sensor between first and second refractory layers;

FIG. 5 is a partial cross-sectional side view of an embodiment of a gasifier refractory lining with first and second sensors between first, second, and third refractory layers;

FIG. 6 is a partial cross-sectional side view of an embodiment of a gasifier refractory lining with a first sensor between first, second, and third refractory layers;

FIG. 7 is a partial cross-sectional side view of an embodiment of a gasifier refractory lining with a first sensor between first, second, and third refractory layers; and

FIG. 8 is an exploded perspective view of an embodiment of a first refractory brick with a sensor mount and a second refractory brick with a cable passage.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments provide a system and method for online, real-time measurements of refractory layer thickness and/or wear of a refractory lining in a reactor, such as a gasifier. For example, the disclosed embodiments mount one or more sensors between refractory layers of the refractory liner, thereby protecting the sensors from the harsh, high temperature environment of the reactor (e.g., gasifier). As a result, the sensors are not directly exposed to the high temperature environment. In certain embodiments, at least one refractor layer is positioned between the sensors and a hot gas path through the reactor (e.g., gasifier). For example, the reactor (e.g., gasifier) may include a first refractor layer facing the hot gas path, a second refractory layer surrounding the first refractory layer, and one or more sensors disposed between the first and second refractory layers. The reactor (e.g., gasifier) also may include a third refractory layer surrounding the second refractory layer, and may further include one or more sensors disposed between the second and third refractory layers. The sensors may include temperature sensors, pressure sensors, or any other suitable sensor. For example, the sensors may be configured to obtain a temperature measurement for use in determining a thickness of the first refractory layer. Due to the intermediate placement of the sensors between the first and second refractory layers, the sensors have a substantially improved life as opposed to sensors placed directly in the hot gas path. Furthermore, the sensors enable online, real-time measurements of refractory layer thickness and/or wear, as well as other parameters, during all stages of operation of the reactor (e.g., gasifier) without shutting down the reactor.

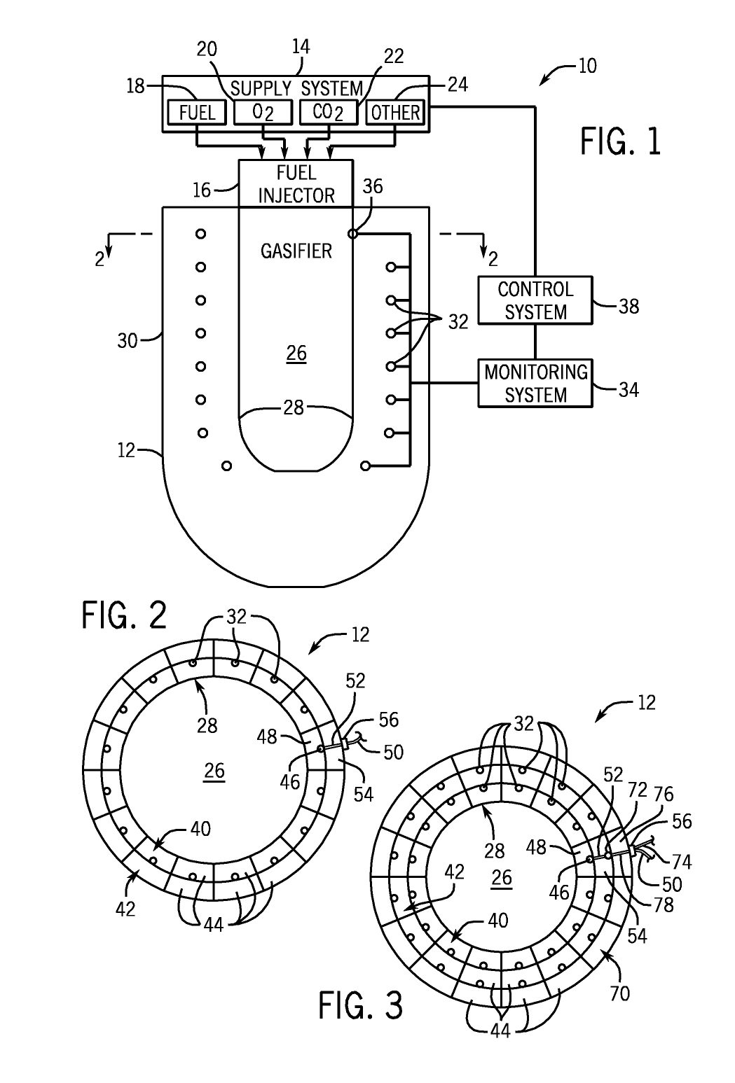

Turning now to the drawings, FIG. 1 is a schematic of a gasifier system 10 that produces and burns a synthetic gas, i.e., syngas. For example, the gasifier system 10 may be a part of a gasification plant or a power plant, such as an integrated gasification combined cycle (IGCC) power plant. However, the disclosed embodiments are not limited to any particular application or reactor, such as the gasification system 10, and thus the disclosed embodiments may be used with any type of reactor. The gasifier system 10 includes a gasifier 12, a supply system 14, and a fuel injector 16. Other elements of the gasifier system 10 include a fuel source 18, an oxygen source 20, and a CO₂ source 22. The fuel source 18 may be a solid fuel or a liquid fuel ,and is utilized as a source of energy for the gasifier system 10. The fuel source 18 may include a feed stock such as coal, petroleum coke, oil, biomass, wood-based materials, agricultural wastes, tars, coke oven gas and asphalt, or other carbon containing items. Additionally, other materials 24 may be provided by the supply system 14. For example, the other materials 24 may include steam for use in converting the feedstock into a syngas.

Next, the fuel, oxygen, CO₂, and other materials are passed to the fuel injector 16. In certain embodiments, the fuel injector 16 combines the various feed streams to the gasifier 12 to promote efficient combustion. The gasifier 12 converts the feedstock from the fuel source 18 into a syngas, e.g., a combination of carbon monoxide and hydrogen. This conversion may be accomplished by subjecting the feedstock to a controlled amount of steam and oxygen at elevated pressures inside a gasification chamber 26, e.g., from approximately 20 bar to 85 bar, and temperatures, e.g., approximately 700 degrees C. to 1600 degrees C., 800 degrees C. to 1400 degrees C., or 1000 degrees C. to 1200 degrees C., depending on the type of gasifier 12 utilized. The gasification process includes the feedstock undergoing a pyrolysis process, whereby the feedstock is heated inside the gasification chamber 26. Depending on the fuel source 18 utilized to generate the feedstock, the temperatures inside the gasification chamber 26 may range from approximately 150 degrees C. to 700 degrees C., 200 degrees C. to 600 degrees C., or 300 degrees C. to 500 degrees C., during the pyrolysis process. The heating of the feedstock during the pyrolysis process generates a solid (e.g., char) and residue gases (e.g., carbon monoxide, hydrogen, and nitrogen). The char remaining from the feedstock from the pyrolysis process may only weigh up to approximately 20%, 30%, or 40% of the weight of the original feedstock.

As shown in the illustrated embodiment, the gasifier 12 further includes a refractory lining 28 and a gasifier shell 30. The refractory lining 28 serves to insulate the gasifier 12 and the gasifier shell 30 from the elevated temperatures and pressures produced by the gasification process described above. The refractory lining 28 is constructed from materials that are designed to withstand elevated temperatures, corrosion, and erosion by gasification products. For example, the refractory lining 28 may be constructed from high alumina, alumina-silicate, chromia-alumina, chrome, and magnesia compositions. In certain embodiments, the refractory lining 28 includes multiple refractory layers. Unfortunately, the harsh environment in the gasification process inevitably causes the refractory lining 28 to experience wear and erosion. Consequently, the refractory lining 28 is periodically replaced to ensure proper protection of the gasifier 12. The replacement process generally involves shut down of the gasifier for a period of time. The cost of replacing the refractory lining 28 can be very high due to material costs as well as the cost of suspended production and gasifier operation.

In order to determine the proper time for replacement of the refractory lining 28, the disclosed embodiments monitor the refractory lining 28 online to determine the level of wear suffered by the refractory lining 28. To obtain refractory lining 28 data and measurements, the gasifier 12 includes sensors 32 disposed between layers of the refractory lining 28. Particularly, the sensors 32 may be disposed behind a first layer of the refractory lining 28, behind a second layer of the refractory lining, and so forth. As described in detail below, the sensors 32 may be configured to obtain a temperature measurement to be used in calculating the thickness of a layer of the refractory lining 28. For example, the sensors 32 may be thermocouples, fiber optic sensors, or other temperature measurement sensors. As will be appreciated, because the sensors 32 are disposed behind at least a first layer of the refractory lining 28, the sensors 32 are shielded from the elevated temperatures and pressures within the gasification chamber 26, resulting in a longer operational life of the sensors 32.

The sensors 32 are further coupled to a monitoring system 34. The monitoring system 34 is configured to monitor measurement data collected by the sensors 32. In certain embodiments, the monitoring system 34 is configured to calculate the thickness of a layer of the refractory lining 28, while the gasifier 12 is operating. For example, the monitoring system 32 may collect temperature measurements using the sensors 32 behind a first layer of the refractory lining 28 during operation of the gasifier 12. The monitoring system 32 then compares the temperatures measured behind the first layer of the refractory lining 28 with a measurement of an operating temperature within the gasification chamber 26, which is obtained by a sensor 36. Specifically, using a known heat transfer coefficient for the first layer of the refractory lining 28, the monitoring system 34 compares the temperature measurement taken behind the first layer of the refractory lining 28 with the gasification chamber operating temperature measurement taken by the sensor 36 to calculate a thickness of the first layer of refractory lining 28. Alternatively, the monitoring system 32 may compare the temperatures behind the first layer of the refractory lining 28 with a baseline measurement taken by the sensors 32 after a new first layer of the refractory lining 28 is installed (i.e., when the first layer of the refractory lining 28 has no wear or erosion). As will be appreciated, the measurements and calculations discussed above may occur while the gasifier 12 is operating (i.e., online) without requiring that the gasifier 12 be temporarily shut down. Additionally, the measurements and calculations may occur in real-time.

Furthermore, the monitoring system 34 communicates with a control system 38 to adjust or modify the operation of the gasifier system 10 based upon the information monitored by the monitoring system 34. For example, the monitoring system 34 can be preset with a lower limit or threshold for the thickness of the refractory lining 28. When the refractory lining 28 or a layer of the refractory lining 28 wears away to the lower limit, the control system 38 communicates with the supply system 14 to modify or shut down the operation of the supply system 14. Additionally, in certain embodiments, the control system 38 may be configured to control or modify the operation of the supply system 14 based on the temperature readings of the sensors 32. As will be appreciated, modifications and adjustments to various operating parameters of the gasifier 12 may be made by the control system 38 during the operation of the gasifier 12, based on information received from the monitoring system 34.

FIG. 2 is a cross-sectional top view of an embodiment of the gasifier 12 of FIG. 1, taken along line 2-2 of FIG. 1, having sensors 32 disposed between layers of the refractory lining 28. Specifically, the refractory lining 28 includes a first refractory layer 40 and a second refractory layer 42. As shown, the first refractory layer 40 and the second refractory layer 42 are each formed from individual refractory bricks 44. The refractory bricks 44 include a first set of bricks 48 in the first refractory layer 40, and a second set of refractory bricks 54 in the second refractory layer 42. The sensors 32 are disposed partially within the refractory bricks 44, 48 of the first refractory layer 40. As discussed in detail below, one or more of the refractory bricks 44, 48 of the first refractory layer 40 include a sensor cavity to support the sensors 32. For example, the sensor cavity may be a groove, notch, hole, or recess. In this manner, the sensors 32 are shielded from the gasification process in the gasification chamber 26 by the refractory bricks 44, 48 of the first refractory layer 40.

As shown in the illustrated embodiment, a first layer sensor 32, 46 is disposed within a first layer refractory brick 44, 48 and is connected to a first lead 50, which passes through the second refractory layer 42. In particular, the first lead 50 passes through a lead passage or cavity 52 of a second layer refractory brick 44, 54. As discussed below, leads of the sensors 32, 46 pass through cavities formed in the refractory bricks 44, 54 of the second refractory layer 42. For example, the lead cavity 52 of the second layer refractory brick 44, 54 may include a notch, tunnel, or other passage to allow the first lead 50 of the first layer sensor 32, 46 to pass through the second refractory layer 42. In this manner, the first lead 50 of the first layer sensor 32, 46 may be protected by the second refractory layer 42 from the gasification process in the gasification chamber 26. In certain embodiments, the first lead 50 may be further protected by a sheath as the first lead 50 passes through the lead cavity 52 of the second layer refractory brick 44, 54. Additionally, the second layer refractory brick 44, 54 includes a lead nozzle 56 through which the first lead 50 of the first layer sensor 32, 46 exits the gasifier 12. It should be appreciated that, while only the first layer sensor 32, 46 is shown to include the first lead 50 passing through the second refractory layer 42 in the illustrated embodiment, others sensors 32 disposed within the first refractory layer 40 may include additional leads which pass through refractory bricks 44, 54 of the second refractory layer 42. Similarly, additional leads may have sheaths and lead nozzles 56 to protect the leads as they pass through the second refractory layer 42.

FIG. 3 is a cross-sectional top view of an embodiment of the gasifier 12 of FIG. 1, taken along line 2-2 of FIG. 1, having sensors 32 disposed between three layers of the refractory lining 28. The illustrated embodiment includes similar elements and similar element numbers as the embodiment of FIG. 2. In addition to the first refractory layer 40 and the second refractory layer 42, the illustrated embodiment also includes a third refractory layer 70, which is formed with refractory bricks 44, 76. In other embodiments, the third refractory layer 70 may be formed with other refractory materials. Additionally, sensors 32 are disposed between the second refractory layer 42 and the third refractory layer 70. As discussed below, one or more of the refractory bricks 44, 54 of the second refractory layer 42 include a sensor cavity to support a sensor 32. For example, the sensor cavity may be a groove, notch, hole, or recess. As shown, a second layer sensor 32, 72 is disposed in a sensor cavity within the second layer refractory brick 54. In this manner, the second layer sensor 32, 72 is protected by the second layer refractory brick 44, 54 and the first layer refractory brick 44, 48 from the gasification process. The second layer sensor 32, 72 is further connected to a second lead 74, which passes through the third refractory layer 70. Specifically, the second lead 74 passes through a third layer refractory brick 44, 76. As discussed below, leads of sensors 32 within the second refractory layer 42 pass through lead cavities formed in the refractory bricks 44, 76 of the third refractory layer 70. For example, the third layer refractory brick 76 includes a lead cavity 78 (e.g., a notch, tunnel, or other passage) to enable the second lead 74 of the second layer sensor 32, 72 to pass through the third refractory layer 70. In this manner, the second lead 74 is protected from the gasification process by the third layer refractory brick 76. Additionally, the second lead 74 may be further protected by a sheath as the second lead 74 passes through the third layer refractory brick 44, 76.

Furthermore, leads of sensors 32, 46 within the first refractory layer 40 may also pass through cavities formed in the refractory bricks 44, 76 of the third refractory layer 70. For example, in the illustrated embodiment, the first lead 50 also passes through the lead cavity 78 in the third layer refractory brick 44, 76. Specifically, the first lead 50 passes through the lead cavity 52 of the second layer refractory brick 44, 54, and continues through the lead cavity 78 of the third layer refractory brick 44, 76. In certain embodiments, the first lead 50 and the second lead 74 may be protected by the same sheath in the lead cavity 78 of the third layer refractory brick 44, 76. In other embodiments, the first lead 50 and the second lead 74 may be protected by separate sheaths in the lead cavity 78. The illustrated embodiment also includes the lead nozzle 56 through which the first lead 50 and the second lead 74 exit the third refractory layer 70 and the gasifier 12. In other embodiments, the first lead 50 and the second lead 74 may exit the third refractory layer 70 through separate lead nozzles 56.

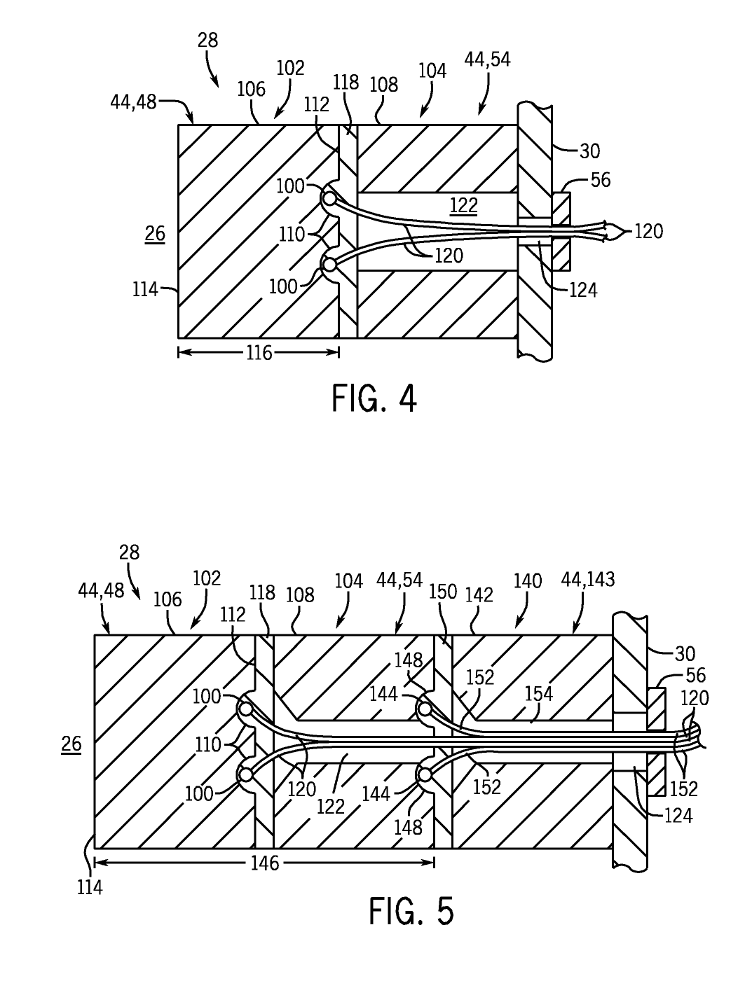

FIG. 4 is a partial cross-sectional side view of an embodiment of the refractory lining 28 of the gasifier 12 of FIG. 1 having first layer sensors 100 disposed between a first refractory layer 102 and a second refractory layer 104 of the refractory lining 28 to shield the sensors first layer 100 from the harsh environment within the gasification chamber 26. In the illustrated embodiment, the first refractory layer 102 includes a first layer refractory brick 106 and the second refractory layer 104 includes a second layer refractory brick 108. The first layer refractory brick 106 includes first sensor cavities 110 formed on an outer face 112 of the first layer refractory brick 106. As shown, the outer face 112 having the first sensor cavities 110 is opposite a hot face 114 of the first layer refractory brick 106, which is exposed to the hot gas path and the gasification reaction in the gasification chamber 26. As discussed above, the first layer sensors 100 may be thermocouples or other temperature sensing devices which are used to collect temperature data for measuring a thickness 116 of the first refractory layer 102. Additionally, the first layer sensors 100 may be other types of sensors used to collect other measurements or data, such as pressure sensors or accelerometers. As the first layer sensors 100 are disposed within the first sensor cavities 110 on the outer face 112 of the first layer refractory brick 106, the first layer sensors 100 are shielded from the elevated temperatures and pressures within the gasification chamber 26. Additionally, the first layer sensors 100 may collect measurement data, while the gasifier 12 is online and operational, without requiring that the gasifier be shut down. The first layer sensors 100 may also enable online, real-time calculation of the thickness 116 of the first refractory layer 102.

The refractory lining 28 in the illustrated embodiment also includes a first intermediate layer 118 disposed between the first and second refractory layers 102 and 104, e.g., between the first layer refractory brick 106 and the second layer refractory brick 108. The first intermediate layer 118 may be configured to provide a cushion, shock absorption, or general resilience between the first and second refractory layers 102 and 104, thereby helping to protect the bricks 106 and 108. The first intermediate layer 118 also serves to hold the sensors 100 in place within the first sensor cavities 110. For example, the first intermediate layer 118 may be made from a fabric, cloth, or other textile material. As shown, first sensor leads 120 of the first layer sensors 100 pass through the first intermediate layer 118 and into a first lead cavity 122 formed through the second layer refractory brick 108. As mentioned above, the first lead cavity 122 may be a tunnel, notch, or other passageway. In the illustrated embodiment, the first lead cavity 122 is formed approximately through the middle of the second layer refractory brick 108. In other embodiments, as discussed below, the first lead cavity 122 may be formed at a side of the second layer refractory brick 108, or between two refractory bricks 44, 108 of the second refractory layer 104. Within the first lead cavity 122, the first sensor leads 120 may be protected by a sheath or other insulative covering.

Thereafter, the first sensor leads 120 pass through an opening 124 of the gasifier shell 30 to exit the gasifier 12. As shown, the lead nozzle 56 extends into and surrounds the opening 124 of the gasifier shell 30. In certain embodiments, the lead nozzle 56 may be a grommet, eyelet, or other ring configured to protect the leads from the edges of the opening 124 of the gasifier shell 30. For example, the lead nozzle 56 may be made from rubber, plastic, or metal. From outside the gasifier 12, the first sensor leads 120 can be connected to the monitoring system 34 or another data acquisition system.

FIG. 5 is a partial cross-sectional side view of an embodiment of the refractory lining 28 of the gasifier 12 of FIG. 1, illustrating a third refractory layer 140 having a third layer refractory brick 142 among a plurality of third layer refractory bricks 143. The illustrated embodiment of the refractory lining 28 includes similar elements and similar element numbers as the embodiment of the refractory lining 28 shown in FIG. 4. Additionally, the illustrated embodiment includes second layer sensors 144 disposed between the second refractory layer 104 and the third refractory layer 140, in addition to the first layer sensors 100 disposed between the first refractory layer 102 and the second refractory layer 104. The second layer sensors 144 may be beneficial in determining a thickness 146 or other properties of the combined first and second refractory layers 102 and 104. In particular, the second layer sensors 144 collect temperature, pressure, and other data for calculating the thickness 146 or other properties of the first and second refractory layers 102 and 104, without requiring that the gasifier 12 be shut down. As the second layer sensors 144 are disposed behind the second refractory layer refractory brick 108, the second layer sensors 144 are shielded from the harsh environment within the gasification chamber 26. Furthermore, in the illustrated embodiment, the second layer refractory brick 108 has second sensor cavities 148 to support the second layer sensors 144. As discussed above, the second sensor cavities 148 may be holes, notches, grooves, or recesses.

The illustrated embodiment also includes a second intermediate layer 150 disposed between the second refractory layer 104 and the third refractory layer 140. The second intermediate layer 150 may be configured to provide a cushion, shock absorption, or general resilience between the second and third refractory layers 104 and 140, thereby helping to protect the bricks 108 and 142. The second intermediate layer 150 serves to hold the second layer sensors 144 in place within the second sensor cavities 148, similar to the first intermediate layer 118. For example, the second intermediate layer 150 may be made from a fabric, cloth, or other textile material. As shown, second sensor leads 152 pass through the second intermediate layer 150 and enter a second lead cavity 154 formed within the third layer refractory brick 142. Additionally, the first sensor leads 120 pass through the second intermediate layer 150 and enter the second lead cavity 154. As mentioned above, the second lead cavity 154 may be a tunnel, notch, or other passageway. In the illustrated embodiment, the second lead cavity 154 is formed approximately in the middle of the third layer refractory brick 142. In other embodiments, the second lead cavity 154 may be formed at a side of the third layer refractory brick 142, or between two refractory bricks 44, 142 of the third refractory layer 140. Within the second lead cavity 154, the fist sensor leads 120 and the second sensor leads 152 may be protected by a sheath or other insulative coating. As mentioned above, the first and second sensor leads 120 and 152 may be wrapped by the same sheath or by separate sheaths.

The first and second sensor leads 120 and 152 exit the gasifier 12 through the opening 124 in the gasifier shell 30. As shown, the lead nozzle 56 extends into and surrounds the opening 124 of the gasifier shell is surrounded by the lead nozzle 56. As discussed above, the lead nozzle 56 may be a grommet, eyelet, or other ring configured to protect the leads from the edges of the opening 124 of the gasifier shell 30. For example, the lead nozzle 56 may be made from rubber, plastic, or metal. From outside the gasifier 12, the first and second sensor leads 120 and 152 can be connected to the monitoring system 34 or another data acquisition system.

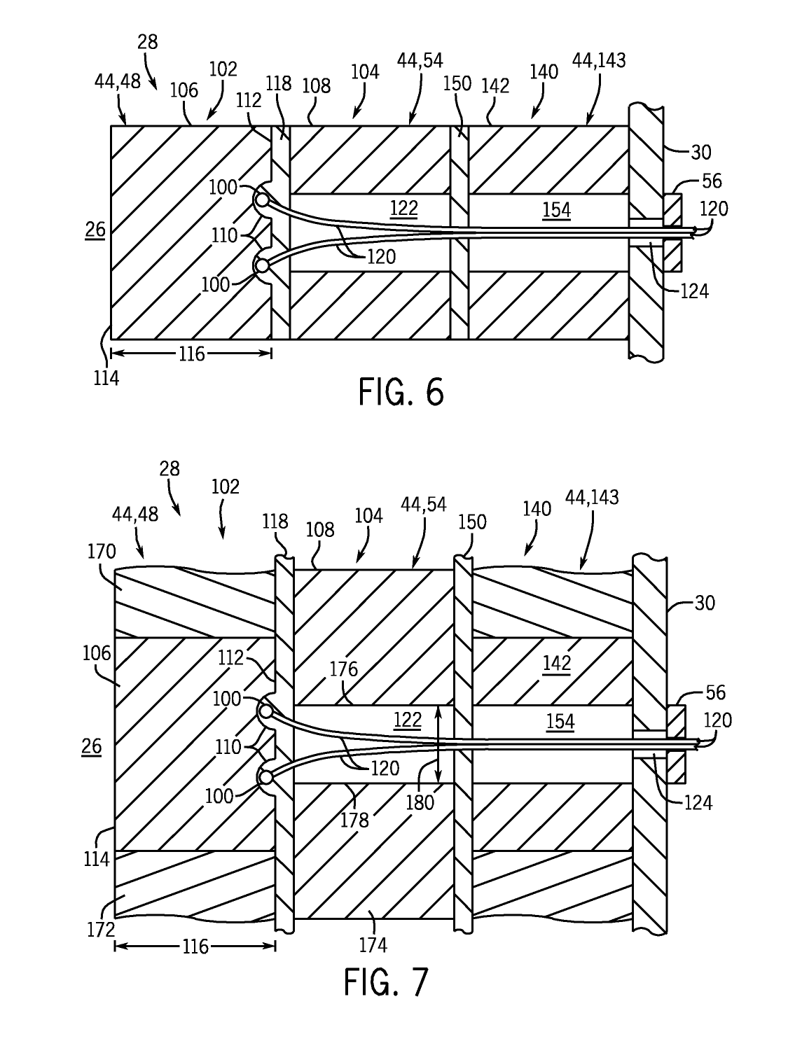

FIG. 6 is a partial cross-sectional side view of an embodiment of the refractory lining 28 of the gasifier 12 of FIG. 1, illustrating the first, second, and third refractory layers 102, 104, and 140 with the first layer sensors 100 disposed between the first refractory layer 102 and the second refractory layer 104. The illustrated embodiment of the refractory lining 28 of the gasifier 12 includes similar elements and element numbers as the embodiment of the refractory lining 28 shown in FIG. 5. In the illustrated embodiment, the first layer sensors 100 are disposed in the first sensor cavities 110, which are formed in the outer face 112 of the first layer refractory brick 106. As the first layer sensors 100 are disposed behind the first layer refractory brick 106, on the side of the first layer refractory brick 106 opposite the hot face 114, the first layer sensors 100 are shielded from the elevated temperatures and pressures within the gasification chamber 26. Additionally, the first layer sensors 100 collect temperature, pressure, and other data for use in calculating the thickness 116 or other properties of the first layer refractory brick 106 while the gasifier 12 is in operation (i.e., without requiring that the gasifier 12 be shut down).

As shown, the first sensor leads 120 connected to the first layer sensors 100 pass through the first intermediate layer 118 and into the first lead cavity 122 of the second layer refractory brick 108. In the illustrated embodiment, the first lead cavity 122 is formed approximately through the middle of the second layer refractory brick 108. In other embodiments, the first lead cavity 122 may be formed in a side of the second layer refractory brick 108 or between two refractory bricks 44, 108 in the second refractory layer 104. Thereafter, the first sensor leads 120 pass through the second intermediate layer 150 and into the second lead cavity 154 of the third layer refractory brick 142. As discussed above, the first sensor leads 120 may be wrapped in a sheath or other insulative coating to protect the first sensor leads 120 within the first and second lead cavities 122 and 154. To exit the gasifier 12, the first sensor leads 120 pass through the opening 124 of the gasifier shell 30, which has the lead nozzle 56. As discussed above, the lead nozzle 56 may be a grommet, eyelet, or other ring to protect the first sensor leads 120 from the edges of the opening 124. From outside the gasifier 12, the first sensor leads 120 may be connected to the monitoring system 34 or another data acquisition system.

FIG. 7 is a partial cross-sectional side view of an embodiment of the refractory lining 28 of the gasifier 12 of FIG. 1, illustrating the first, second, and third refractory layers 102, 104, and 140 with the first layer sensors 100 disposed between the first and second refractory layers 102 and 104. As the first layer sensors 100 are disposed behind the first layer refractory brick 106 (i.e., within the outer face 112 of the first layer refractory brick 106, opposite the hot face 114 exposed to the gasification chamber 26), the first layer sensors 100 are protected from the harsh environment and the elevated temperatures and pressures within the gasification chamber 26. The illustrated embodiment of the refractory lining 28 of the gasifier 12 includes similar elements and element numbers as the embodiment of the refractory lining 28 illustrated in FIG. 6. In the illustrated embodiment, the refractory bricks 44, 48 of the first refractory layer 102 are staggered with respect to the refractory bricks 44, 54 of the second refractory layer 104. Similarly, the refractory bricks 44, 54 of the second refractory layer 104 are staggered with respect to the refractory bricks 44, 143 of the third refractory layer 140. As will be appreciated, the staggered arrangement of the refractory bricks 44, 48, 54, and 143 further blocks hot gases from reaching the first layer sensors 100 and the sensor leads 120. In other words, the staggered bricks 44, 48, 54, and 143 block head, pressure, and so forth from the gasification process in the gasification chamber 26.

The first refractory layer 102 includes the first layer refractory brick 106 and additional first layer refractory bricks 170 and 172. The first layer sensors 100 are disposed within the first sensor cavities 110 formed in the outer face 112 of the first layer refractory brick 106. The first sensor leads 120 pass from the first layers sensors 100, through the first intermediate layer 118, and into the first lead cavity 122. In the illustrated embodiment, the first lead cavity 122 is formed in between two refractory bricks 44, 54 of the second refractory layer 104. Specifically, the first lead cavity 122 is formed in between the second layer refractory brick 108 and a second layer refractory brick 174. In certain embodiments, the first lead cavity 122 may be formed by forming a groove, notch, or mount only in a side 176 of the second layer refractory brick 108. In other embodiments, the first lead cavity 122 may be formed by forming a groove, notch, or mount both in the side 176 of the second layer refractory brick 108 and in a side 178 of the second layer refractory brick 174. In still other embodiments, during the assembly of the second refractory layer 104, the second layer refractory bricks 108 and 174 may be spaced a distance 180 apart to create the first lead cavity 122, e.g., using a spacer.

After the first sensor leads 120 pass through the first lead cavity 122, the first sensor leads 120 pass through the second intermediate layer 150 and into the second lead cavity 154. In the illustrated embodiment, the second lead cavity 154 is formed approximately in the middle of the third layer refractory brick 142. The first sensor leads 120 exit the gasifier 12 through the opening 124 in the gasifier shell 30. As discussed above, the opening 124 in the gasifier shell 30 is filled with and/or surrounded by the lead nozzle 56, which may serve to protect the first sensor leads 120 from the edges of the opening 124. From outside the gasifier 12, the first sensor leads 120 can be connected to the monitoring system 34 or another data acquisition system.

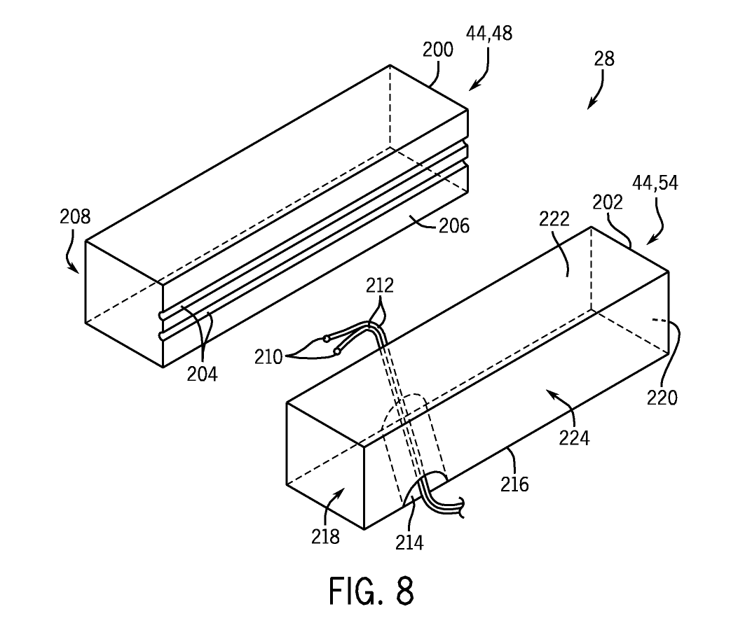

FIG. 8 is a partial exploded perspective view of an embodiment of the refractory lining 28 of the gasifier 12 of FIG. 1, illustrating a first refractory brick 200 and a second refractory brick 202, where the second refractory brick 202 is disposed behind the first refractory brick 200. For example, the first refractory brick 200 may be a part of the first refractory layer 44, 48 and the second refractory brick 202 may be a part of the second refractory layer 44, 54. As shown, the first refractory brick 200 has sensor cavities 204 formed on an outer surface 206 of the first refractory brick 200. Specifically, the first refractory brick 200 has two sensor cavities 204 formed in the outer surface 206. Other embodiments of the first refractory brick 200 may include 1, 3, 4, 5, or more sensor cavities 204 formed in the outer surface 206. Further, the sensor cavities 204 are formed on the opposite side of a surface 208, which may be a hot surface (i.e., a surface that faces and/or is exposed to the gasification chamber 26) The sensor cavities 204 are configured to receive sensors 210. As discussed above, the sensors 210 may be thermocouples, fiber optic sensors, or other measurements sensors configured to collect temperature, pressure, or other data.

The sensors 210 are connected to sensor leads 212, which pass through the second refractory brick 202. Specifically, the sensor leads 212 pass through a sensor lead cavity 214 formed through the second refractory brick 202. As discussed above, the sensor lead cavity 214 may be a tunnel, notch, groove, or other passageway. In the illustrated embodiment, the sensor lead cavity 214 is formed on a bottom 216 of the second refractory brick 202 and has an angled orientation. In other embodiments, the sensor lead cavity 214 may be formed on a side 218 or 220, a top 222, or through a middle 224 of the second refractory brick 202. Additionally, other embodiments of the sensor lead cavity 214 may have other angled orientations or may be generally parallel to the sides 218 and 220 of the second refractory brick 202. After the sensor leads 212 exit the sensor lead cavity 214, the sensor leads 212 may pass through another refractory layer or the gasifier shell 30, and then be connected to the monitoring system 34 or another data acquisition system.

As discussed above, embodiments of the present disclosure provide for a refractory lining 28 having refractory bricks 44, 106, 108 with sensor cavities 110, 148 formed in the refractory bricks 44, 106, 108. Specifically, the sensor cavities are 110, 148 are formed on the outer face 112 of the refractory bricks 44, 106, 108, which is opposite the hot face 114 of the refractory bricks 44, 106, 108 facing the gasification chamber 26. Sensors 100, 144, such as temperature or other sensors, are disposed in the sensor cavities 110, 148 and, as a result, are protected from the elevated temperatures and pressures produced by the gasification process inside the gasification chamber 26. The sensors 100, 144 collect data, such as temperature measurements, which can be used to determine or calculate thicknesses 116 or other properties of the refractory lining 28. Furthermore, the thicknesses 116 or other properties may be determined in real-time, and without shutting down the gasifier 12 (i.e., the measurements and calculations may be made while the gasifier 12 is online). Specifically, using a known heat transfer coefficient of the refractory bricks 44, 106, 108, the thicknesses 116 can be calculated by comparing a baseline measurement or a measurement within the gasification chamber 26 (e.g., a temperature measurement) to the measurements and data collected by the sensors 100, 144.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gasifier, comprising:
a first refractory layer disposed about a gasification chamber;
a second refractory layer disposed about the first refractory layer;
an enclosure disposed about the second refractory layer; and
a first temperature sensor disposed between the first and second refractory layers.

2. The system of claim 1, comprising a monitoring system configured to determine a first thickness of the first refractory layer based on a first temperature measurement from the first temperature sensor.

3. The system of claim 2, comprising a gasification temperature sensor exposed to the gasification chamber, wherein the monitoring system is configured to determine the first thickness of the first refractory layer based on the first temperature measurement from the first temperature sensor and a gasification temperature measurement from the gasification temperature sensor.

4. The system of claim 1, wherein the first temperature sensor comprises a first thermocouple.

5. The system of claim 1, wherein the first temperature sensor comprises an optical temperature sensor.

6. The system of claim 1, wherein the first refractory layer comprises a plurality of first refractory bricks, and the second refractory layer comprises a plurality of second refractory bricks.

7. The system of claim 6, wherein the plurality of first refractory bricks and the plurality of second refractory bricks are staggered relative to one another.

8. The system of claim 1, comprising a third refractory layer disposed between the enclosure and the second refractory layer, and a second temperature sensor disposed between the second and third refractory layers.

9. The system of claim 8, wherein the first refractory layer comprises a plurality of first refractory bricks, the second refractory layer comprises a plurality of second refractory bricks, and the third refractory layer comprises a plurality of third refractory bricks.

10. The system of claim 1, comprising a fabric layer disposed between the first and second refractory layers.

11. The system of claim 1, wherein the first refractory layer comprises a protected surface opposite from an exposed surface, the exposed surface faces the gasification chamber, the protected surface faces the second refractory layer, and the protected surface comprises at least one recess supporting the temperature sensor.

12. A system, comprising:
a gasifier, comprising:
a first refractory layer comprising a plurality of first refractory bricks disposed about a gasification chamber;
a second refractory layer comprising a plurality of second refractory bricks disposed about the first refractory layer;
an enclosure disposed about the second refractory layer; and
a first sensor disposed between the first and second refractory layers.

13. The system of claim 12, wherein the first sensor comprises a pressure sensor.

14. The system of claim 12, wherein the first sensor comprises a gas analyzing system configured to measure a gas composition in the gasification chamber.

15. The system of claim 12, wherein the first sensor comprises a temperature sensor, and the system comprises a monitoring system configured to determine a first thickness of the first refractory layer based on a first temperature measurement from the temperature sensor.

16. The system of claim 12, comprising a third refractory layer having a plurality of third refractory bricks disposed between the enclosure and the second refractory layer, and a second sensor disposed between the second and third refractory layers.

17. The system of claim 12, wherein each brick of the plurality of first refractory bricks comprises a protected surface opposite from an exposed surface, the exposed surfaces face the gasification chamber, the protected surfaces face the second refractory layer, and at least one brick of the plurality of first refractory bricks comprises at least one recess supporting the first sensor along the protected surface.

18. A system, comprising:
a first gasifier refractory brick, comprising:
a gasification hot face configured to face a gasification chamber inside a gasifier;
a protected face opposite from the gasification hot face; and
a sensor mount disposed along the protected face.

19. The system of claim 18, wherein the sensor mount comprises a sensor mounting recess.

20. The system of claim 19, comprising a second gasifier refractory brick configured to mount adjacent the protected face of the first gasifier refractory brick, wherein the second gasifier refractory brick comprises a cable passage configured to route a cable to a sensor disposed in the sensor mounting recess.
